(19) United States
(12) Patent Application Publication
(10) Pub. No.: US 2026/0358202 A1
(43) Pub. Date: Nov. 12, 2026

(54) TEST DEVICE, TEST METHOD USING THE SAME, ELECTRONIC DEVICE INCLUDING WINDOW TESTED BY THE SAME

(71) Applicant: Samsung Display Co., LTD., Yongin-si (KR)

(72) Inventors: SANGHYUK JEONG, Yongin-si (KR); SAEROM KIM, Yongin-si (KR)

(21) Appl. No.: 19/568,985

(22) Filed: Mar. 17, 2026

(30) Foreign Application Priority Data
May 12, 2025 (KR) 10-2025-0061407

(51) Int. Cl. G01M 99/00; G06F 1/16

(52) U.S. Cl. CPC G01M 99/005; G06F 1/1652

(57) ABSTRACT

A test device includes a first plate including a first upper surface on which a first non-folding area of a test object is disposed, a second plate that is spaced apart from the first plate in a first direction and that includes a second upper surface on which a second non-folding area of the test object is disposed, a center part disposed under the first plate and the second plate, and a stage disposed under the center part. A groove that overlaps a folding area of the test object disposed between the first non-folding area and the second non-folding area is defined on an upper surface of the center part.

This application claims priority to Korean Patent Application No. 10-2025-0061407, filed on May 12, 2025, and all the benefits accruing therefrom under 35 U.S.C. §119, the content of which in its entirety is herein incorporated by reference.

### BACKGROUND

### 1. Field

Embodiments of the disclosure described herein relate to a test device, a test method using the same, and an electronic device including a window tested by the same.

### 2. Description of the Related Art

Electronic devices, such as a smart phone, a digital camera, a notebook computer, a car navigation device, and a smart television, which provide an image to a user include a display device for displaying the image. The display device includes a display panel for generating the image, an input device such as an input sensing part, a camera for taking an external image, and various sensors.

Recently, with the development of display device technology, various types of display devices are being developed. For example, various flexible display devices capable of being transformed into a curved shape, folded, or rolled are being developed. The flexible display devices whose shapes are capable of being transformed in various ways are easy to carry and improve user convenience.

Among the flexible display devices, a foldable display device is folded about a folding axis extending in one direction. The foldable display device is folded or unfolded about the folding axis. The foldable display device includes a folding area that is bent in a folding operation. The folding area may be bent to have a predetermined radius of curvature. A test device capable of easily testing a folded state of the folding area is desired.

### SUMMARY

Embodiments of the present disclosure provide a test device for easily testing a folded state of a folding area of a window, a test method using the test device, and an electronic device including a window tested by the test device.

In an embodiment, a test device includes a first plate including a first upper surface on which a first non-folding area of a test object is disposed, a second plate that is spaced apart from the first plate in a first direction and that includes a second upper surface on which a second non-folding area of the test object is disposed, a center part disposed under the first plate and the second plate, and a stage disposed under the center part. A groove that overlaps a folding area of the test object disposed between the first non-folding area and the second non-folding area is defined on an upper surface of the center part.

In an embodiment, a test method includes an operation of placing, on a first plate and a second plate spaced apart from each other in a first direction, a test object including a first non-folding area that overlaps the first plate, a second non-folding area that overlaps the second plate, and a folding area disposed between the first non-folding area and the second non-folding area, an operation of making the first non-folding area and the second non-folding area face each other by rotating the first plate about a first rotation axis and rotating the second plate about a second rotation axis, in which the first rotation axis extends in a second direction crossing the first direction and is defined next (adjacent) to one side of the first plate that faces one side of the second plate, and the second rotation axis extends in the second direction and is defined next (adjacent) to the one side of the second plate that faces the one side of the first plate, and an operation of pressing the folding area using a center part disposed on an upper surface of a stage by moving the stage upward by a predetermined distance in a third direction crossing a plane defined by the first direction and the second direction, the stage being disposed under the folding area, and a groove that overlaps the folding area is defined on an upper surface of the center part.

In an embodiment, an electronic device includes a processor and a display device that receives an image signal from the processor and provides an image corresponding to the image signal to a user. The display device includes a display panel and a window disposed on the display panel and tested by a test device including a first plate including a first upper surface on which a first non-folding area of the window is disposed, a second plate that is spaced apart from the first plate in a first direction and that includes a second upper surface on which a second non-folding area of the window is disposed, a center part disposed under the first plate and the second plate, and a stage disposed under the center part. A groove that overlaps a folding area of the window disposed between the first non-folding area and the second non-folding area is defined on an upper surface of the center part.

### BRIEF DESCRIPTION OF THE DRAWINGS

The above and other embodiments, advantages and features of the disclosure will become apparent by describing in detail embodiments thereof with reference to the accompanying drawings.

FIG. 1 is a perspective view of an embodiment of a test device of the disclosure.

FIG. 2 is a block diagram of an embodiment of an electronic device including a test object tested using the test device of the disclosure.

FIG. 3 illustrates schematic views of embodiments of electronic devices.

FIG. 4 is a perspective view of an embodiment of an electronic device of the disclosure.

FIG. 5 is a view illustrating a folded state of the electronic device illustrated in FIG. 4.

FIG. 6 is a perspective view of an embodiment of an electronic device of the disclosure.

FIG. 7 is a view illustrating a folded state of the electronic device illustrated in FIG. 6.

FIG. 8 is an exploded perspective view of the electronic device illustrated in FIG. 4.

FIG. 9 is a view illustrating a cross-section of a display panel used in a display device illustrated in FIG. 8.

FIG. 10 is a cross-sectional view of the display device corresponding to line A-A’ illustrated in FIG. 8.

FIG. 11 is a perspective view of a first support plate illustrated in FIG. 10.

FIG. 12 is an enlarged plan view of area AA illustrated in FIG. 11.

FIG. 13 is a view illustrating a folded state of the display device illustrated in FIG. 10.

FIGS. 14-21 are cross-sectional views of the test device and the test object corresponding to line I-I’ illustrated in FIG. 1, where FIGS. 14-21 illustrate operations of a test method using the test device.

### DETAILED DESCRIPTION

In this specification, when a component (or, an area, a layer, a part, etc.) is referred to as being “on”, “connected to” or “coupled to” another component, this means that the component may be directly on, connected to, or coupled to the other component or a third component may be therebetween.

Identical reference numerals refer to identical components. Additionally, in the drawings, the thicknesses, proportions, and dimensions of components are exaggerated for effective description. As used herein, the term “and/or” includes all of one or more combinations defined by related components.

Terms such as first, second, and the like may be used to describe various components, but the components should not be limited by the terms. The terms may be used only for distinguishing one component, part, area, layer, or portion from other components, parts, areas, layers, or portions. For example, without departing the scope and scope of the disclosure, a first component, a first part, a first area, a first layer, or a first portion may be referred to as a second component, a second part, a second area, a second layer, or a second portion, and similarly, the second component, the second part, the second area, the second layer, or the second portion may also be referred to as the first component, the first part, the first area, the first layer, or the first portion. The terms of a singular form may include plural forms unless otherwise specified.

In addition, terms such as “below”, “under”, “above”, and “over” are used to describe a relationship between components illustrated in the drawings. The terms are relative concepts and are described based on directions illustrated in the drawing.

It should be understood that terms such as “comprise”, “include”, and “have”, when used herein, specify the presence of stated features, numbers, steps, operations, components, parts, or combinations thereof, but do not preclude the presence or addition of one or more other features, numbers, steps, operations, components, parts, or combinations thereof.

Unless otherwise defined, all terms used herein, including technical or scientific terms, have the same meanings as those generally understood by those skilled in the art to which the disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the application.

Hereinafter, embodiments of the disclosure will be described with reference to the accompanying drawings.

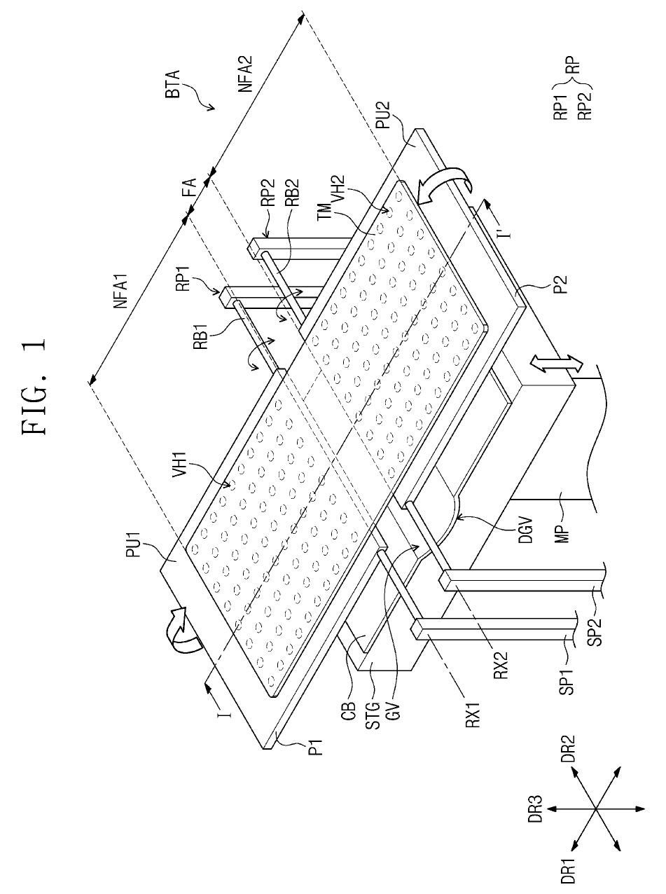

FIG. 1 is a perspective view illustrating an embodiment of a test device and a test object disposed on the test device of the disclosure.

Referring to FIG. 1, the test device BTA may include a first plate P1, a second plate P2, a center part CB, a stage STG, a plurality of rotating parts RP, and a moving part MP.

Hereinafter, a first direction DR1 and a second direction DR2 substantially perpendicular to each other are defined, and a direction substantially perpendicular to a plane defined by the first direction DR1 and the second direction DR2 is defined as a third direction DR3. The expression “when viewed from above the plane” used herein may mean a state in which it is viewed in the third direction DR3. In addition, the term “overlap” used herein may indicate a state in which components are disposed to overlap each other when viewed from above the plane.

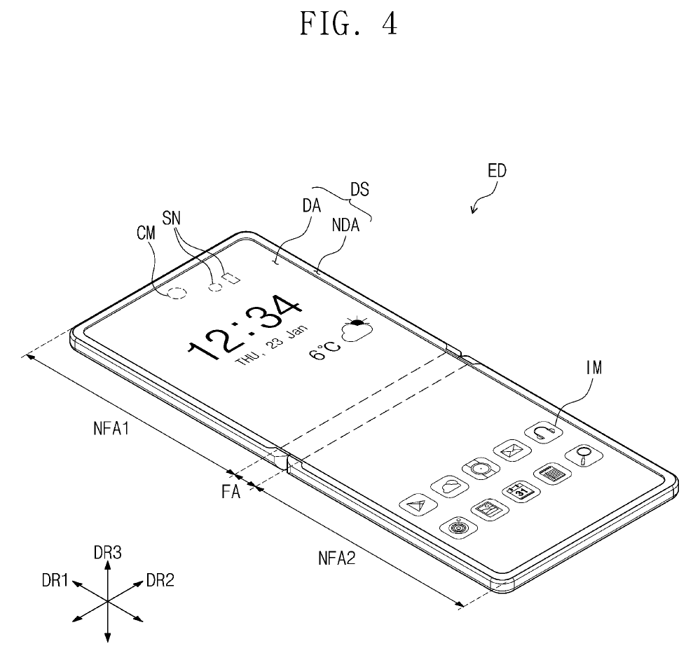

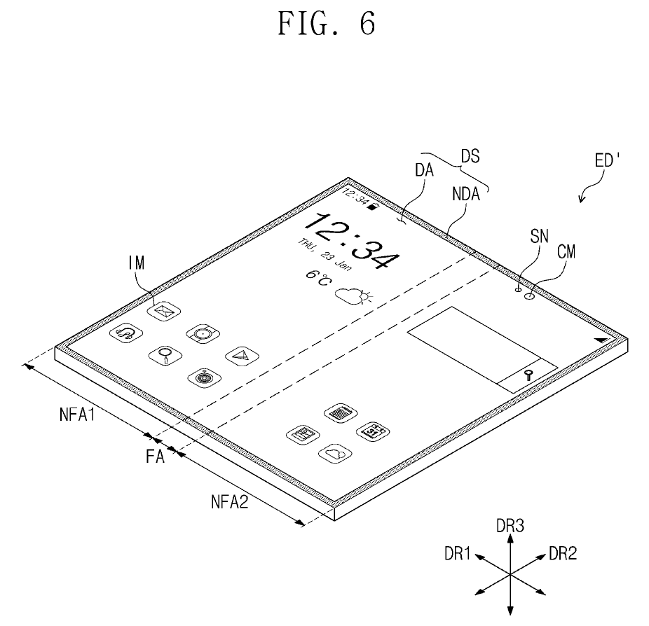

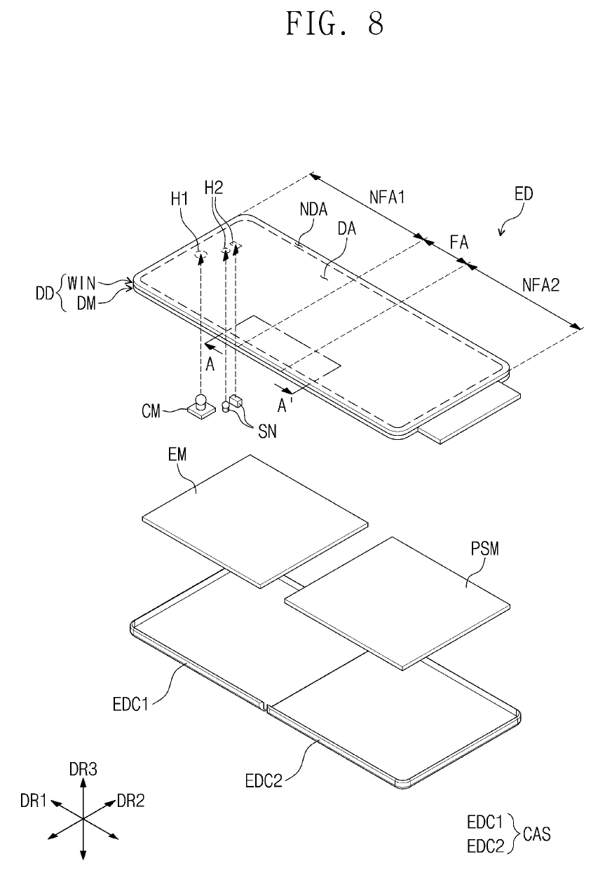

The test object TM may include a first non-folding area NFA1, a folding area FA, and a second non-folding area NFA2. The first non-folding area NFA1, the folding area FA, and the second non-folding area NFA2 of the test object TM may correspond to a first non-folding area NFA1, a folding area FA, and a second non-folding area NFA2 of an electronic device ED (illustrated in FIG. 4) or ED’ (illustrated in FIG. 6) or a display device DD (illustrated in FIG. 8), respectively, which will be described below. The folding area FA may be next (adjacent) to the first non-folding area NFA1 and the second non-folding area NFA2 and may be disposed between the first non-folding area NFA1 and the second non-folding area NFA2. Accordingly, the first non-folding area NFA1, the folding area FA, and the second non-folding area NFA2 may be arranged in the first direction DR1.

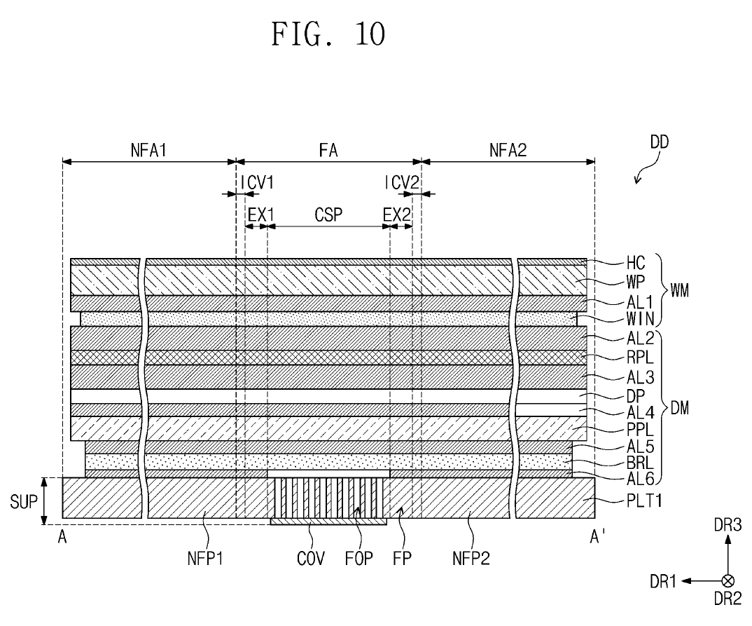

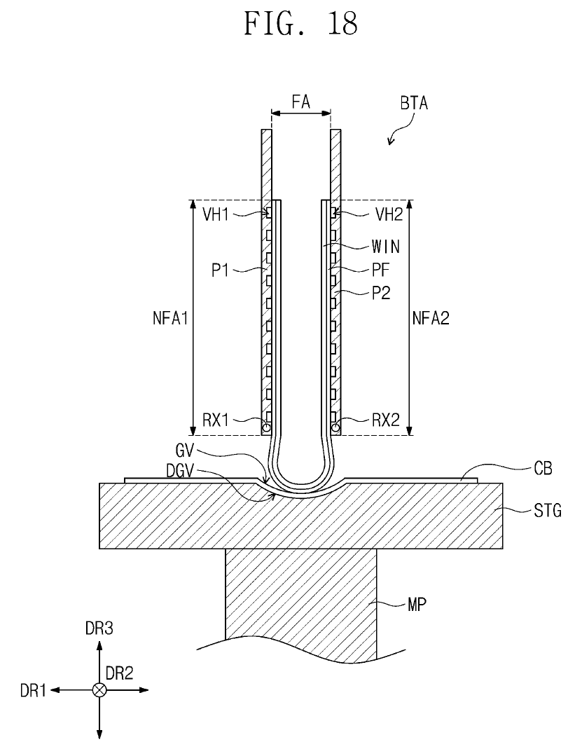

The test object TM may include a single layer or a plurality of layers. In an embodiment, the test object TM may include a window WIN (illustrated in FIG. 10). In addition, the test object TM may include the window WIN and a protective film PF (illustrated in FIG. 18) that is disposed on the lower surface of the window WIN, for example. However, without being limited thereto, the test object TM may include various layers. The test object TM may be a flexible test object.

The first plate P1 may have sides extending in the first direction DR1 and sides extending in the second direction DR2. An upper surface PU1 of the first plate P1 may have a plane defined by the first direction DR1 and the second direction DR2. A plurality of first vacuum holes VH1 may be defined in the first plate P1. Specifically, the plurality of first vacuum holes VH1 may be defined in the upper surface PU1 of the first plate P1.

The first vacuum holes VH1 may fix the test object TM. Specifically, the first non-folding area NFA1 of the test object TM may be disposed on the upper surface PU1 of the first plate P1. Accordingly, the first non-folding area NFA1 may overlap the upper surface PU1 of the first plate P1. When the first non-folding area NFA1 of the test object TM is disposed on the upper surface PU1 of the first plate P1, the first vacuum holes VH1 may be maintained in a vacuum state so that the first non-folding area NFA1 of the test object TM may be attracted to the upper surface PU1 of the first plate P1. Accordingly, the first non-folding area NFA1 of the test object TM may be fixed to the upper surface PU1 of the first plate P1.

The second plate P2 may have sides extending in the first direction DR1 and sides extending in the second direction DR2. An upper surface PU2 of the second plate P2 may have a plane defined by the first direction DR1 and the second direction DR2. A plurality of second vacuum holes VH2 may be defined in the second plate P2. Specifically, the plurality of second vacuum holes VH2 may be defined in the upper surface PU2 of the second plate P2.

The second vacuum holes VH2 may fix the test object TM. Specifically, the second non-folding area NFA2 of the test object TM may be disposed on the upper surface PU2 of the second plate P2. Accordingly, the second non-folding area NFA2 may overlap the upper surface PU2 of the second plate P2. When the second non-folding area NFA2 of the test object TM is disposed on the upper surface PU2 of the second plate P2, the second vacuum holes VH2 may be maintained in a vacuum state so that the second non-folding area NFA2 of the test object TM may be attracted to the upper surface PU2 of the second plate P2. Accordingly, the second non-folding area NFA2 of the test object TM may be fixed to the upper surface PU2 of the second plate P2. The shapes and numbers of the first vacuum holes VH1 and the second vacuum holes VH2 are not limited to those illustrated in FIG. 1.

The second plate P2 may be spaced apart from the first plate P1 in the first direction DR1 and may be disposed parallel to the first plate P1. Since the first plate P1 and the second plate P2 are spaced apart from each other, the folding area FA of the test object TM disposed between the first non-folding area NFA1 of the test object TM disposed on the upper surface PU1 of the first plate P1 and the second non-folding area NFA2 of the test object TM disposed on the upper surface PU2 of the second plate P2 may not overlap the first plate P1 and the second plate P2.

The center part CB may be disposed under the first plate P1 and the second plate P2. The center part CB may overlap a partial area of the first plate P1 and a partial area of the second plate P2 when viewed from above the plane. The center part CB may overlap a partial area of the first non-folding area NFA1, the folding area FA, and a partial area of the second non-folding area NFA2 of the test object TM.

The stage STG may be disposed under the center part CB. The stage STG may support the center part CB. The center part CB may be disposed on the upper surface of the stage STG. Since the center part CB and the stage STG are not integrally formed (or unitary) with each other, the center part CB that has reached the end of its life may be easily replaced with another center part CB. The stage STG may overlap a partial area of the first plate P1 and a partial area of the second plate P2. The stage STG may overlap a partial area of the first non-folding area NFA1, the folding area FA, and a partial area of the second non-folding area NFA2 of the test object TM.

Hereinafter, a “thickness” used herein may be defined as a numerical value measured in the third direction DR3. A “width” used herein may be defined as a numerical value measured in a horizontal direction (e.g., the first direction DR1 or the second direction DR2).

The stage STG may have a greater width than the center part CB. The periphery of center part CB may be disposed inward of the periphery of the stage STG. The center part CB may have a constant thickness.

A groove GV overlapping the folding area FA of the test object TM may be defined on the upper surface of the center part CB. The groove GV may be recessed such that the upper surface of the center part CB is concave downward. When viewed in the second direction DR2, the groove GV may have a curved surface that is concave downward in the third direction DR3. The groove GV may extend in the second direction DR2. The groove GV may be defined in a shape corresponding to the curved surface of the folding area FA when the folding area FA is folded.

A dummy groove DGV may be defined on the upper surface of the stage STG. The dummy groove DGV defined on the upper surface of the stage STG may overlap the groove GV of the center part CB. The dummy groove DGV may be recessed such that the upper surface of the stage STG is concave downward. When viewed in the second direction DR2, the dummy groove DGV may have a curved surface that is concave downward in the third direction DR3. The dummy groove DGV may extend in the second direction DR2. The dummy groove DGV may be defined in a shape corresponding to the curved surface of the groove GV.

The stage STG may be of a rigid type. The center part CB may include a flexible material. Accordingly, when the center part CB is attached to the upper surface of the stage STG, the center part CB may be deformed in a shape corresponding to the upper surface of the stage STG. As a result, the groove GV of the center part CB may be defined by the dummy groove DGV of the stage STG.

The moving part MP may be disposed under the stage STG. The stage STG may be vertically moved in the third direction DR3 by the moving part MP. As the stage STG is vertically moved, the center part CB disposed on the upper surface of the stage STG may be vertically moved in the third direction DR3. The shape and structure of the moving part MP illustrated in FIG. 1 are illustrative, and the moving part MP may have various shapes and structures and is not limited to a particular embodiment, as long as the moving part MP is capable of moving the stage STG and the center part CB.

The rotating parts RP may include a first rotating part RP1 and a second rotating part RP2. The first rotating part RP1 may include a plurality of first support columns SP1 and a first rotating bar RB1. The second rotating part RP2 may include a plurality of second support columns SP2 and a second rotating bar RB2. In an embodiment, two first support columns SP1 and two second support columns SP2 are illustrated, and the number of support columns is not limited thereto, for example.

The first support columns SP1 may extend in the third direction DR3 and may be spaced apart from each other in the second direction DR2 with the first plate P1 therebetween. The first rotating bar RB1 may extend in the second direction DR2 to pass through the first plate P1. The first rotating bar RB1 may define a first rotation axis RX1 (or which is a first axis of rotation) parallel to the second direction DR2. The first rotating bar RB1 may connect the two first support columns SP1 spaced apart from each other in the second direction DR2. Accordingly, the first support columns SP1 and the first rotating bar RB1 may be arranged in the second direction DR2.

The second support columns SP2 may extend in the third direction DR3 and may be spaced apart from each other in the second direction DR2 with the second plate P2 therebetween. The second rotating bar RB2 may extend in the second direction DR2 to pass through the second plate P2. The second rotating bar RB2 may define a second rotation axis RX2 (or which is a second axis of rotation) parallel to the second direction DR2. The second rotating bar RB2 may connect the two second support columns SP2 spaced apart from each other in the second direction DR2. Accordingly, the second support columns SP2 and the second rotating bar RB2 may be arranged in the second direction DR2. The first rotating part RP1 and the second rotating part RP2 may be spaced apart from each other in the first direction DR1 and may be parallel to each other.

The first rotation axis RX1 may be defined next (adjacent) to one side of the first plate P1 that faces one side of the second plate P2. The second rotation axis RX2 may be defined next (adjacent) to the one side of the second plate P2 that faces the one side of the first plate P1.

The first plate P1 may rotate about the first rotation axis RX1. The second plate P2 may rotate about the second rotation axis RX2. The first plate P1 and the second plate P2 may rotate in opposite directions to fold the folding area FA. In an embodiment, to fold the folding area FA, the first plate P1 may rotate clockwise about the first rotation axis RX1, and the second plate P2 may rotate counterclockwise about the second rotation axis RX2, for example. Accordingly, the first plate P1 and the second plate P2 may rotate about the first rotation axis RX1 and the second rotation axis RX2 in the opposite directions so that the first non-folding area NFA1 and the second non-folding area NFA2 of the test object TM may be rotated to face each other.

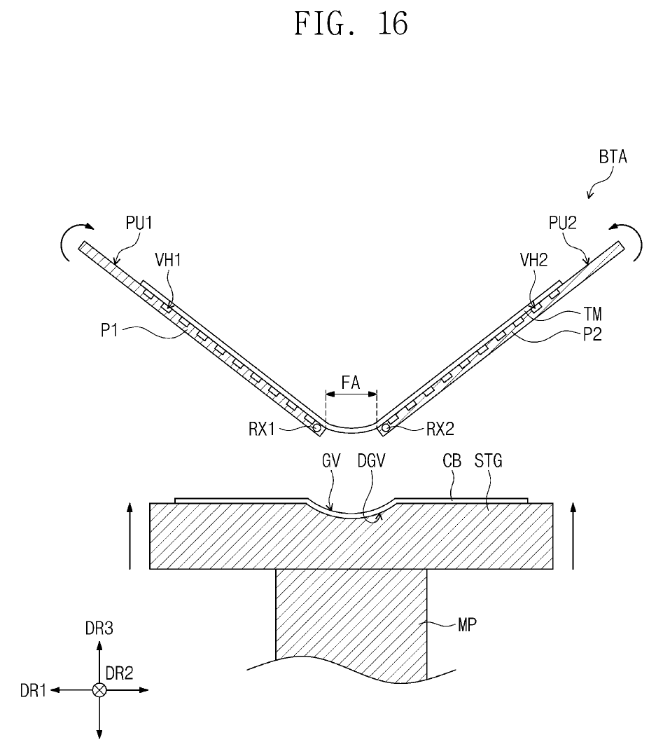

When the first plate P1 and the second plate P2 rotate, the stage STG may be moved upward by a predetermined distance in the third direction DR3 by the moving part MP. As the stage STG is moved upward in the third direction DR3, the center part CB may also be moved upward in the third direction DR3. This process will be described below in detail with reference to FIG. 16. The shape and structure of the rotating parts RP illustrated in FIG. 1 are illustrative, and the rotating parts RP may have various shapes and structures and are not limited to a particular embodiment, as long as the rotating parts RP are capable of rotating the first plate P1 and the second plate P2.

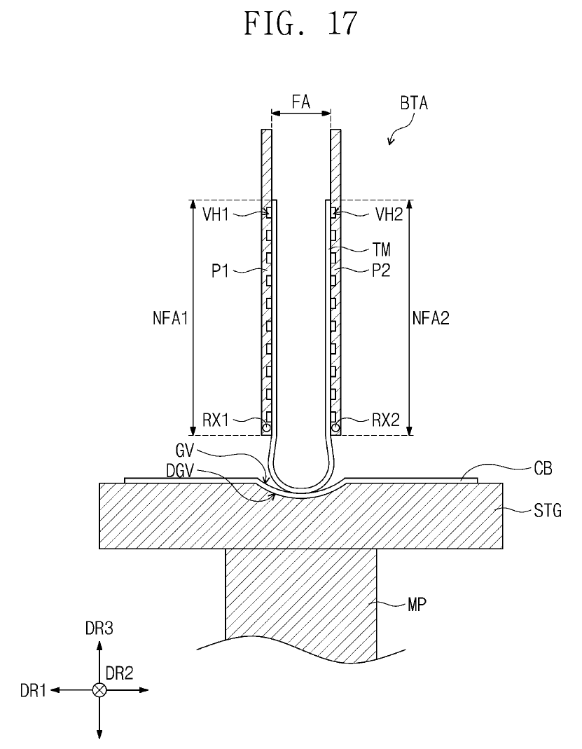

When the first plate P1 and the second plate P2 rotate and the stage STG and the center part CB move upward in the third direction DR3, the folding area FA of the test object TM may be brought into contact with the groove GV of the center part CB and may be pressed by the groove GV of the center part CB. As the folding area FA is pressed, the test object TM may be folded in a dumbbell shape. This process will be described below in detail with reference to FIGS. 17 and 18.

To reduce damage to the test object TM when the center part CB contacts the test object TM and presses the test object TM, the center part CB may include a flexible material having a ductile material. The center part CB may have a lower hardness than the test object TM. In an embodiment, the center part CB may include silicone or rubber, for example. However, without being limited thereto, the center part CB may include various materials and is not limited to a particular embodiment, as long as damage to the test object TM is capable of being reduced.

The test object TM tested by the test device BTA may be determined to be normal or defective depending on whether the test object TM is damaged. When the test object TM tested by the test device BTA is not damaged, the test object TM may be determined to be normal and may be used in a subsequent process (e.g., a process of attaching the window WIN to a display module DM (illustrated in FIG. 10)). When the test object TM tested by the test device BTA is damaged, the test object TM may be determined to be defective and may be discarded.

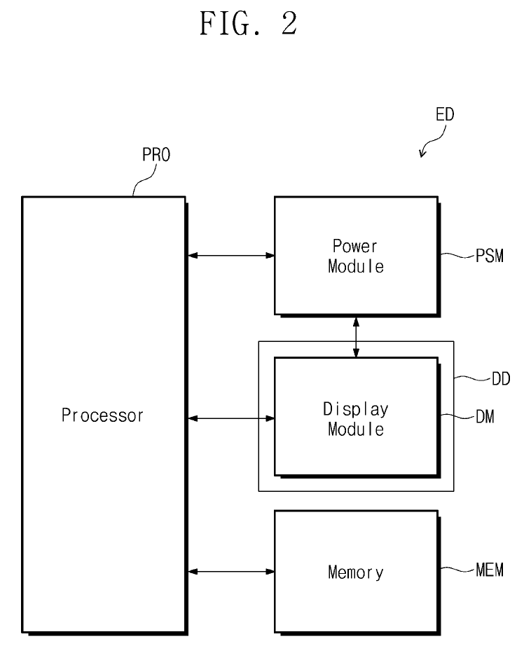

FIG. 2 is a block diagram of an embodiment of an electronic device including the test object tested using the test device of the disclosure.

Referring to FIG. 2, the electronic device ED including the test object tested using the test device in an embodiment of the disclosure may include the display device DD that provides an image to a user and may further include modules or devices having other additional functions, in addition to the display device DD. The electronic device ED in an embodiment may include a display module DM, a processor PRO, a memory MEM, and a power module PSM, and the display device DD may include the display module DM. The display device DD may include the above-described window as the test object.

The processor PRO may include at least one of a central processing unit (“CPU”), an application processor (“AP”), a graphic processing unit (“GPU”), a communication processor (“CP”), an image signal processor (“ISP”), and a controller.

The processor PRO may process an image signal and may provide the processed image signal to the display device DD. The display device DD may receive the image signal from the processor PRO and may provide an image corresponding to the image signal to the user.

The processor PRO may be electrically connected to the display module DM of the display device DD through a flexible circuit board and a connector. The display module DM may display an image based on data received from the processor PRO.

In an embodiment, the processor PRO may be divided into two or more parts from a functional or structural point of view. In an embodiment, the processor PRO may include a main processor in the form of a first driver integrated circuit (“IC”) that includes a central processing unit and an auxiliary processor in the form of a second driver IC that includes a controller that receives an image signal from the main processor and processes the image signal according to the interface specifications of the display module DM, for example.

Data information desired for operation of the processor PRO or the display module DM may be stored in the memory MEM. When the processor PRO executes an application stored in the memory MEM, an image signal and/or an input control signal may be transferred to the display module DM, and the display module DM may process the provided signal and may output image information through a display screen.

The power module PSM may include a power supply module such as a power adapter or a battery device and a power conversion module that converts power supplied by the power supply module and generates power desired for operation of the electronic device ED.

At least one of the components of the electronic device ED described above may be included in the display device DD according to the above-described embodiments. In addition, some of the separate modules functionally included in one module may be included in the display device DD, and remaining (the other) separate modules may be provided separately from the display device DD.

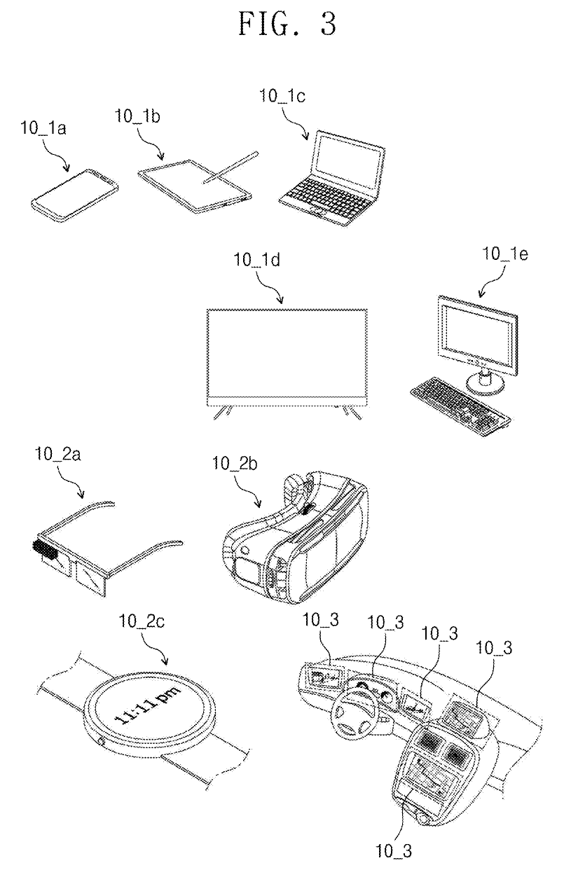

FIG. 3 illustrates schematic views of embodiments of electronic devices.

Referring to FIG. 3, the display device DD in an embodiment of the disclosure may be applied to various electronic devices. In an embodiment, the various electronic devices to which the display device DD in an embodiment is applied may include electronic devices for displaying images, such as a smart phone 10_1a, a tablet PC 10_1b, a laptop computer 10_1c, a television (“TV”) 10_1d, and a desk monitor 10_1e, for example.

Furthermore, the various electronic devices to which the display device DD in an embodiment is applied may include wearable electronic devices, such as smart glasses 10_2a, a head mounted display 10_2b, and a smart watch 10_2c. In addition, the various electronic devices to which the display device DD in an embodiment is applied may include vehicle electronic devices 10_3, such as center information displays (“CID”) disposed on an instrument panel, a center fascia, and a dashboard of a vehicle and a room mirror display.

FIG. 4 is a perspective view of an embodiment of an electronic device of the disclosure.

Referring to FIG. 4, the electronic device ED including the test object in an embodiment of the disclosure may have long sides extending parallel to each other in the first direction DR1 and short sides extending parallel to each other in the second direction DR2 crossing the first direction DR1. The corners of the electronic device ED that connect the long sides and the short sides of the electronic device ED may have a curved shape. The corners of the electronic device ED that have a curved shape may be defined as rounded corners. The shape of the electronic device ED may be defined as a rounded quadrangular shape.

The electronic device ED may include a folding area FA and a plurality of non-folding areas next (adjacent) to the folding area FA. The non-folding areas may include a first non-folding area NFA1 and a second non-folding area NFA2. The folding area FA may be disposed between the first non-folding area NFA1 and the second non-folding area NFA2. The first non-folding area NFA1, the folding area FA, and the second non-folding area NFA2 may be arranged in the first direction DR1.

Although one folding area FA and two non-folding areas NFA1 and NFA2 are illustrated in an embodiment, the number of folding areas and the number of non-folding areas are not limited thereto. In an embodiment, the electronic device ED may include more than two non-folding areas and a plurality of folding areas disposed between the non-folding areas, for example.

The upper surface of the electronic device ED may be defined as a display surface DS and may have a plane defined by the first direction DR1 and the second direction DR2. Images IM generated in the folding area FA may be provided to the user through the display surface DS.

The display surface DS may include a display area DA and a non-display area NDA around the display area DA. The display area DA may display an image, and the non-display area NDA may not display an image. The non-display area NDA may surround the display area DA and may define the border of the electronic device ED that is printed in a predetermined color.

The electronic device ED may include a plurality of sensors SN and at least one camera CM. The sensors SN and the camera CM may be next (adjacent) to the border of the electronic device ED. The sensors SN and the camera CM may be disposed in the display area DA next (adjacent) to the non-display area NDA. The sensors SN and the camera CM may be disposed in the first non-folding area NFA1, but the placement positions of the sensors SN and the camera CM are not limited thereto.

In an embodiment, the sensors SN may be proximity illuminance sensor, but the type of sensors SN is not limited thereto, for example. The camera CM may take an external image.

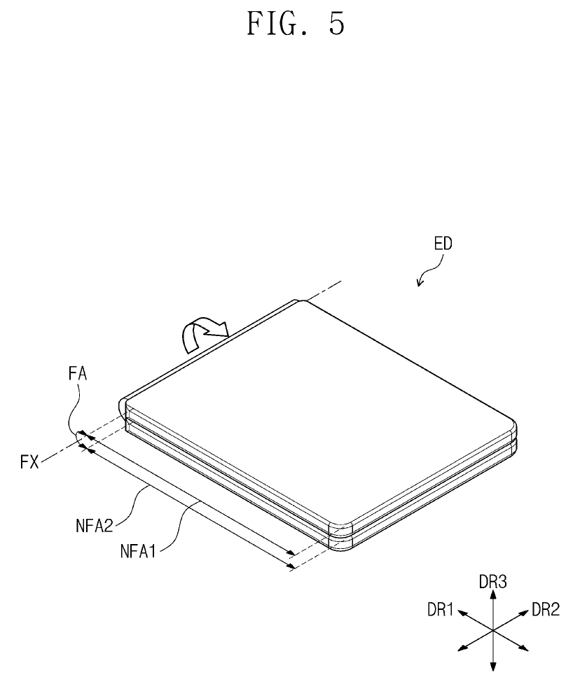

FIG. 5 is a view illustrating a folded state of the electronic device illustrated in FIG. 4.

Referring to FIGS. 4 and 5, the electronic device ED may be a flexible electronic device. In an embodiment, the electronic device ED may be a foldable electronic device that is folded or unfolded, for example. In an embodiment, the folding area FA may be bent about a folding axis FX parallel to the second direction DR2 so that the electronic device ED may be folded, for example. The folding axis FX may be defined as a short axis parallel to the short sides of the electronic device ED.

When the electronic device ED is folded, the first non-folding area NFA1 and the second non-folding area NFA2 may face each other, and the electronic device ED may be folded in an inner-folding manner such that the display surface DS is not exposed to the outside. However, embodiments of the disclosure are not limited thereto. In an embodiment, the electronic device ED may be folded about the folding axis FX in an out-folding manner such that the display surface DS is exposed to the outside, for example.

Although not illustrated, the display device DD (illustrated in FIG. 2) of the electronic device ED may be folded in a dumbbell shape.

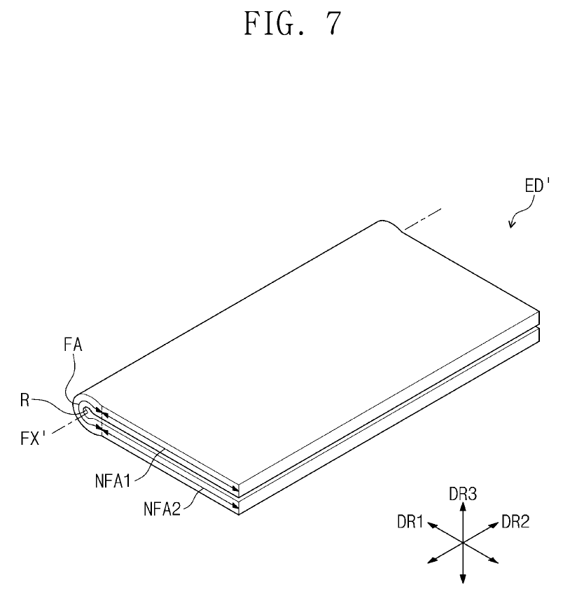

FIG. 6 is a perspective view of an embodiment of an electronic device of the disclosure. FIG. 7 is a view illustrating a folded state of the electronic device illustrated in FIG. 6.

The electronic device ED’ may have short sides extending in the first direction DR1 and long sides extending in the second direction DR2. The electronic device ED’ may be a foldable electronic device. In an embodiment, a folding area FA may be bent about a folding axis FX’ parallel to the second direction DR2 so that the electronic device ED’ may be folded, for example. The folding axis FX’ may be defined as a short axis parallel to the long sides of the electronic device ED’. Other configurations of the electronic device ED' may be substantially the same as those of the electronic device ED illustrated in FIGS. 4 and 5.

When the electronic device ED’ is folded, the distance between a first non-folding area NFA1 and a second non-folding area NFA2 may be smaller than the diameter of the circle defined by the radius of curvature R of the folding area FA. In this case, the folding area FA may be folded in a dumbbell shape, and the distance between the first non-folding area NFA1 and the second non-folding area NFA2 may be further decreased.

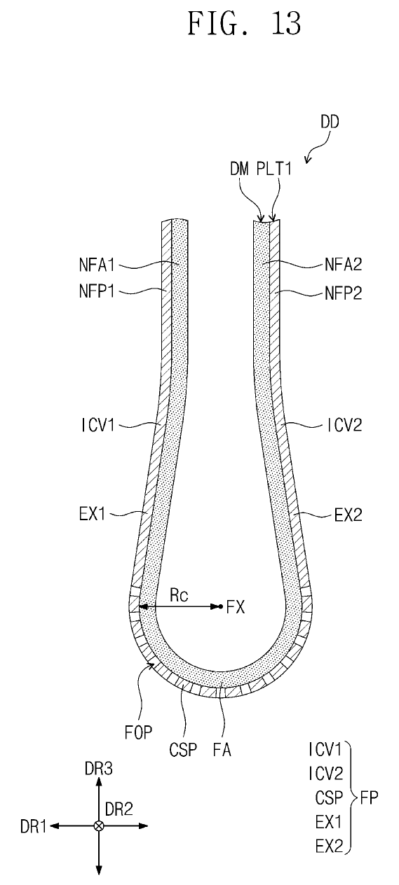

Although not illustrated in FIG. 5, the electronic device ED (refer to FIG. 5) may also be folded in a dumbbell shape, like the electronic device ED’, and this shape is illustrated in FIG. 13.

In FIGS. 4 and 6, for example, the electronic device ED is illustrated as a smart phone and the electronic device ED' is illustrated as a smart phone. These may be the smart phone 10_1a illustrated in FIG. 3. However, without being limited thereto, the electronic device ED and ED' may include various electronic devices. In an embodiment, the electronic device ED and ED' may include relatively large electronic devices such as a television, a monitor, and a billboard, for example. In an alternative embodiment, the electronic device ED and ED' may include relatively small and medium-sized electronic devices such as a personal computer, a notebook computer, a car navigation device, a game machine, a tablet computer, and a camera.

FIG. 8 is an exploded perspective view of the electronic device illustrated in FIG. 4.

Referring to FIG. 8, the electronic device ED may include the display device DD, the camera CM, the sensors SN, an electronic module EM, the power module PSM, and a case CAS.

The display device DD may have long sides extending in the first direction DR1 and short sides extending in the second direction DR2 crossing the first direction DR1. The display area DD may have a rounded quadrangular shape to correspond to the shape of the electronic device ED.

The display device DD may include a first non-folding area NFA1, a folding area FA, and a second non-folding area NFA2. The first non-folding area NFA1, the folding area FA, and the second non-folding area NFA2 of the display device DD may correspond to the first non-folding area NFA1, the folding area FA, and the second non-folding area NFA2 of the electronic device ED illustrated in FIG. 4, respectively, and are assigned with the same reference numerals for convenience of description. Accordingly, in the display device DD, the folding area FA may be disposed between the first non-folding area NFA1 and the second non-folding area NFA2, and the first non-folding area NFA1, the folding area FA, and the second non-folding area NFA2 may be arranged in the first direction DR1.

The display device DD may include a display area DA and a non-display area NDA surrounding the display area DA. The display area DA may display an image, and the non-display area NDA may not display an image. The display area DA and the non-display area NDA of the display device DD may correspond to the display area DA and the non-display area NDA of the electronic device ED illustrated in FIG. 4, respectively, and are assigned with the same reference numerals for convenience of description.

The display device DD may have a first hole area H1 and second hole areas H2 defined therein. Although not illustrated, holes may be defined in the first hole area H1 and the second hole areas H2, respectively. The holes may be defined in the display module DM. In an embodiment, the camera CM may be disposed in the hole defined in the first hole area H1, and the sensors SN may be disposed in the holes defined in the second hole areas H2, for example.

The display device DD may include the display module DM and the window WIN disposed on the display module DM. The display module DM may generate an image. The image generated by the display module DM may transmit through the window WIN and may be provided to the user. The window WIN may protect the display module DM from external scratches and impacts.

The electronic module EM and the power module PSM may be disposed under the display device DD. Although not illustrated, the electronic module EM and the power module PSM may be connected with each other through a flexible circuit board. The electronic module EM may control operation of the display module DM. The power module PSM may supply power to the display module DM. The electronic module EM may include the above-described processor PRO (illustrated in FIG. 2).

The case CAS may accommodate the display device DD, the camera (hereinafter also referred to as a camera module) CM, the sensors SN, the electronic module EM, and the power module PSM. The case CAS may protect the display device DD, the camera module CM, the sensors SN, the electronic module EM, and the power module PSM.

To fold the display device DD, the case CAS may include a first case EDC1 and a second case EDC2 arranged in the first direction DR1. The first case EDC1 may overlap the first non-folding area NFA1, and the second case EDC2 may overlap the second non-folding area NFA2.

Although not illustrated, the electronic device ED may further include a hinge structure connected to the first case EDC1 and the second case EDC2 to control a folding operation of the electronic device ED.

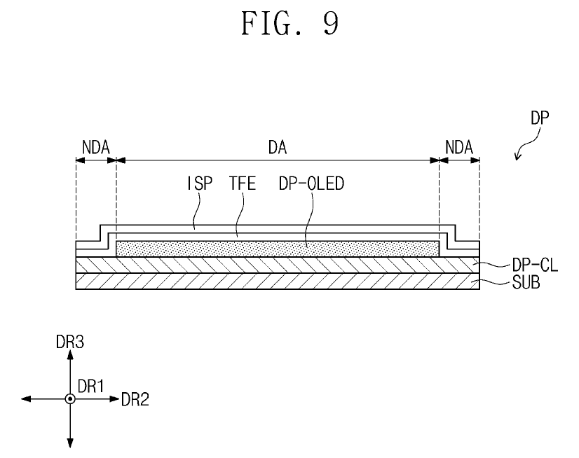

FIG. 9 is a view illustrating a cross-section of a display panel used in the display device illustrated in FIG. 8.

In an embodiment, in FIG. 9, a cross-section of the display panel DP viewed in the first direction DR1 is illustrated, for example.

The display panel DP in an embodiment of the disclosure may be an emissive display panel. In an embodiment, the display panel DP may be an organic light-emitting display panel or an inorganic light-emitting display panel, for example. A light-emitting layer of the organic light-emitting display panel may include an organic luminescent material. A light-emitting layer of the inorganic light-emitting display panel may include a quantum dot and a quantum rod. Hereinafter, it will be exemplified that the display panel DP is an organic light-emitting display panel.

Referring to FIG. 9, the display panel DP may include a substrate SUB, a circuit element layer DP-CL disposed on the substrate SUB, a display element layer DP-OLED disposed on the circuit element layer DP-CL, a thin film encapsulation layer TFE disposed on the display element layer DP-OLED, and an input sensing part ISP disposed on the thin film encapsulation layer TFE.

The substrate SUB may include a display area DA and a non-display area NDA around the display area DA. The display element layer DP-OLED may overlap the display area DA when viewed from above the plane. The substrate SUB may include a flexible plastic material. In an embodiment, the substrate SUB may include polyimide (“PI”), for example.

The circuit element layer DP-CL may include transistors. The display element layer DP-OLED may include light-emitting elements connected to the transistors. Although not illustrated, the display panel DP may include pixels. In addition, the pixels may include transistors and light-emitting elements.

The thin film encapsulation layer TFE may be disposed on the circuit element layer DP-CL to cover the display element layer DP-OLED. The thin film encapsulation layer TFE may include an inorganic layer, an organic layer, and an inorganic layer sequentially stacked one above another. The inorganic layers may include an inorganic material and may protect the pixels from moisture/oxygen. The organic layer may include an organic material and may protect the pixels from foreign matter such as dust particles.

The input sensing part ISP may include a plurality of sensors (not illustrated) for sensing an external input. The sensors may sense the external input in a capacitive type. The external input may include various types of inputs such as a part of the user’s body, light, heat, a pen, or pressure.

The input sensing part ISP may be directly manufactured on the thin film encapsulation layer TFE when the display panel DP is manufactured. However, without being limited thereto, the input sensing part ISP may be manufactured as a panel separate from the display panel DP and may be attached to the display panel DP by an adhesive layer.

FIG. 10 is a cross-sectional view of the display device corresponding to line A-A’ illustrated in FIG. 8.

Referring to FIG. 10, the display device DD may include a window module WM, the display module DM disposed under the window module WM, and a support part SUP disposed under the display module DM to support the display module DM.

The window module WM and the display module DM may be a flexible window module and a flexible display module. The display module DM and the window module WM may include a folding area FA and a first non-folding area NFA1 and a second non-folding area NFA2 that are next (adjacent) to the folding area FA. The folding area FA and the first and second non-folding areas NFA1 and NFA2 next (adjacent) to the folding area FA may correspond to the folding area FA and the first and second non-folding areas NFA1 and NFA2 next (adjacent) to the folding area FA of the display device DD illustrated in FIG. 8, respectively, and are assigned with the same reference numerals for convenience of description. Accordingly, in the display module DM and the window module WM, the folding area FA may be disposed between the first non-folding area NFA1 and the second non-folding area NFA2, and the first non-folding area NFA1, the folding area FA, and the second non-folding area NFA2 may be arranged in the first direction DR1.

Hereinafter, detailed components of the window module WM, the display module DM, and the support part SUP will be described based on a flat state of the display device DD.

The window module WM may include a hard coating layer HC, a window protection layer WP, the window WIN, and a first adhesive layer AL1.

The display module DM may include an anti-reflective layer RPL, the display panel DP, a panel protection layer PPL, a barrier layer BRL, and second to sixth adhesive layers AL2 to AL6.

The hard coating layer HC, the window protection layer WP, the window WIN, and the anti-reflective layer RPL may be disposed on the display panel DP. The panel protection layer PPL and the barrier layer BRL may be disposed under the display panel DP.

The anti-reflective layer RPL may be disposed on the display panel DP. The anti-reflective layer RPL may be defined as a film for preventing reflection of external light. The anti-reflective layer RPL may decrease the reflectance of external light incident toward the display panel DP from the outside.

When the external light traveling toward the display panel DP is reflected by the display panel DP and then provided back to the user, the user may visually recognize the external light as in a mirror. To prevent such a phenomenon, for example, the anti-reflective layer RPL may include a plurality of color filters that display the same colors as the pixels.

The color filters may filter the external light in the same colors as the pixels. In this case, the external light may not be visible to the user. However, without being limited thereto, the anti-reflective layer RPL may include a phase retarder and/or a polarizer to decrease the reflectance of the external light.

The window WIN may be disposed on the anti-reflective layer RPL. The window WIN may protect the display panel DP and the anti-reflective layer RPL from external scratches. The window WIN may have a property of being optically clear. The window WIN may include glass. However, without being limited thereto, the window WIN may include a synthetic resin film.

The window WIN may have a single-layer structure or a multi-layer structure. In an embodiment, the window WIN may include a plurality of synthetic resin films coupled through an adhesive or may include a glass substrate and a synthetic resin film coupled through an adhesive, for example.

The window protection layer WP may be disposed on the window WIN. The window protection layer WP may include a flexible plastic material such as polyimide or polyethylene terephthalate (“PET”).

The hard coating layer HC may be disposed on the window protection layer WP.

The first adhesive layer AL1 may be disposed between the window protection layer WP and the window WIN. The window protection layer WP and the window WIN may be bonded to each other by the first adhesive layer AL1.

The second adhesive layer AL2 may be disposed between the window WIN and the anti-reflective layer RPL. The window WIN and the anti-reflective layer RPL may be bonded to each other by the second adhesive layer AL2.

The third adhesive layer AL3 may be disposed between the anti-reflective layer RPL and the display panel DP. The anti-reflective layer RPL and the display panel DP may be bonded to each other by the third adhesive layer AL3.

The panel protection layer PPL may be disposed under the display panel DP. The panel protection layer PPL may protect the bottom of the display panel DP. The panel protection layer PPL may include a flexible plastic material. In an embodiment, the panel protection layer PPL may include polyethylene terephthalate, for example.

The barrier layer BRL may be disposed under the panel protection layer PPL. The barrier layer BRL may increase resistance to a compressive force caused by external pressing. Accordingly, the barrier layer BRL may serve to prevent deformation of the display panel DP. The barrier layer BRL may include a flexible plastic material such as polyimide or polyethylene terephthalate.

The barrier layer BRL may have a color that absorbs light. The barrier layer BRL may have a black color. In this case, components disposed under the barrier layer BRL may not be visible when the display module DM is viewed from above the plane.

The fourth adhesive layer AL4 may be disposed between the display panel DP and the panel protection layer PPL. The display panel DP and the panel protection layer PPL may be bonded to each other by the fourth adhesive layer AL4.

The fifth adhesive layer AL5 may be disposed between the panel protection layer PPL and the barrier layer BRL. The panel protection layer PPL and the barrier layer BRL may be bonded to each other by the fifth adhesive layer AL5.

The sixth adhesive layer AL6 may be disposed under the barrier layer BRL. The sixth adhesive layer AL6 may be disposed between the barrier layer BRL and a first support plate PLT1 of the support part SUP. The barrier layer BRL and the first support plate PLT1 may be bonded to each other by the sixth adhesive layer AL6.

The first to sixth adhesive layers AL1 to AL6 may include a transparent adhesive such as a pressure sensitive adhesive (“PSA”) or an optically clear adhesive (“OCA”), but the type of adhesive is not limited thereto.

The panel protection layer PPL may have a smaller thickness than the window protection layer WP, the anti-reflective layer RPL may have a smaller thickness than the panel protection layer PPL, and the display panel DP may have a smaller thickness than the anti-reflective layer RPL. The window WIN may have the same thickness as the anti-reflective layer RPL. The barrier layer BRL may have a smaller thickness than the panel protection layer PPL and may have a greater thickness than the anti-reflective layer RPL.

The first adhesive layer AL1 may have the same thickness as the barrier layer BRL, and the second adhesive layer AL2 and the third adhesive layer AL3 may have the same thickness as the panel protection layer PPL. Each of the fourth adhesive layer AL4 and the fifth adhesive layer AL5 may have a smaller thickness than the display panel DP. The fourth adhesive layer AL4 and the fifth adhesive layer AL5 may have the same thickness. The sixth adhesive layer AL6 may have a smaller thickness than the fourth adhesive layer AL4 and the fifth adhesive layer AL5, and the hard coating layer HC may have a smaller thickness than the sixth adhesive layer AL6.

The display panel DP, the anti-reflective layer RPL, the panel protection layer PPL, and the second to fourth adhesive layers AL2 to AL4 may have the same width.

The window protection layer WP, the hard coating layer HC, and the first adhesive layer AL1 may have the same width.

The window WIN may have a smaller width than the display panel DP, the anti-reflective layer RPL, the panel protection layer PPL, and the second to fourth adhesive layers AL2 to AL4. In addition, the window module WIN may have a smaller width than the window protection layer WP, the hard coating layer HC, and the first adhesive layer AL1.

The barrier layer BRL may have the same width as the fifth adhesive layer AL5 and the sixth adhesive layer AL6.

When viewed from above the plane, the border of the window WIN may be disposed inward of the borders of the display panel DP, the anti-reflective layer RPL, the panel protection layer PPL, and the second to fourth adhesive layers AL2 to AL4. Furthermore, when viewed from above the plane, the border of the window WIN may be disposed inward of the borders of the window protection layer WP, the hard coating layer HC, and the first adhesive layer AL1. In addition, when viewed from above the plane, the borders of the barrier layer BRL, the fifth adhesive layer AL5, and the sixth adhesive layer AL6 may be disposed inward of the border of the window WIN.

The support part SUP may include the first support plate PLT1 and a cover layer COV.

The first support plate PLT1 may be disposed under the display module DM to support the display module DM. The first support plate PLT1 may have a higher rigidity than the display module DM. Folding openings FOP overlapping the folding area FA may be defined in the first support plate PLT1.

The first support plate PLT1 may include a metallic material such as stainless steel. In an embodiment, the first support plate PLT1 may include stainless steel 304 (“SUS304”), for example. However, without being limited thereto, the first support plate PLT1 may include various metallic materials. In addition, without being limited thereto, the first support plate PLT1 may include a non-metallic material such as glass or plastic.

The first support plate PLT1 may include a first non-folding portion NFP1, a folding portion FP, and a second non-folding portion NFP2. In an embodiment, the boundaries between the first non-folding portion NFP1, the folding portion FP, and the second non-folding portion NFP2 are illustrated by dotted lines on the first support plate PLT1, for example. The first non-folding portion NFP1, the folding portion FP, and the second non-folding portion NFP2 may be arranged in the first direction DR1. The folding portion FP may be disposed between the first non-folding portion NFP1 and the second non-folding portion NFP2. The folding openings FOP may be defined in the folding portion FP.

The first non-folding portion NFP1 may be disposed under the first non-folding area NFA1 and may overlap the first non-folding area NFA1. The second non-folding portion NFP2 may be disposed under the second non-folding area NFA2 and may overlap the second non-folding area NFA2. The folding portion FP may be disposed under the folding area FA and may overlap the folding area FA. The folding portion FP may be folded when the display device DD is folded. A folded state of the folding portion FP will be described below in detail with reference to FIG. 13.

The folding portion FP may include a curved portion CSP, a first extension EX1, a second extension EX2, a first reverse curvature portion ICV1, and a second reverse curvature portion ICV2. In an embodiment, the boundaries between the curved portion CSP, the first extension EX1, the second extension EX2, the first reverse curvature portion ICV1, and the second reverse curvature portion ICV2 are illustrated by dotted lines on the first support plate PLT1, for example. For convenience, the reference numerals are illustrated over the window module WIN, with the dotted boundary lines extended upward.

The first reverse curvature portion ICV1, the first extension EX1, the curved portion CSP, the second extension EX2, and the second reverse curvature portion ICV2 may be arranged in the first direction DR1.

The curved portion CSP may be disposed between the first extension EX1 and the second extension EX2. In an embodiment, the curved portion CSP may be disposed at the center of the folding portion FP, for example. The folding openings FOP may be defined in the curved portion CSP. Since the folding openings FOP are defined in the curved portion CSP, the flexibility of the curved portion CSP may be increased. In this case, the curved portion CSP may be easily folded when the folding portion FP is folded. A folded state of the curved portion CSP will be described below in detail with reference to FIG. 13.

The sixth adhesive layer AL6 may not overlap the curved portion CSP. That is, the sixth adhesive layer AL6 may be open in the area overlapping the curved portion CSP.

The first extension EX1 may be disposed between the first reverse curvature portion ICV1 and the curved portion CSP. The second extension EX2 may be disposed between the second reverse curvature portion ICV2 and the curved portion CSP.

The first reverse curvature portion ICV1 may be disposed between the first extension EX1 and the first non-folding portion NFP1. The second reverse curvature portion ICV2 may be disposed between the second extension EX2 and the second non-folding portion NFP2.

The cover layer COV may be disposed under the first support plate PLT1. The cover layer COV may overlap the first non-folding portion NFP1, the curved portion CSP, and the second non-folding portion NFP2. The cover layer COV may cover the folding openings FOP, which are defined in the curved portion CSP, from below the curved portion CSP. The cover layer COV may not overlap the first reverse curvature portion ICV1, the first extension EX1, the second extension EX2, and the second reverse curvature portion ICV2.

The cover layer COV may have a lower elastic modulus than the first support plate PLT1. In an embodiment, the cover layer COV may include thermoplastic polyurethane or rubber, but the material of the cover layer COV is not limited thereto, for example. The cover layer COV may be manufactured in a sheet shape and may be attached to the first support plate PLT1.

The width of the first support plate PLT1 may be greater than the width of the window module WM and the width of the display module DM. When viewed from above the plane, the borders of the window module WM and the display module DM may be disposed inward of the border of the first support plate PLT1.

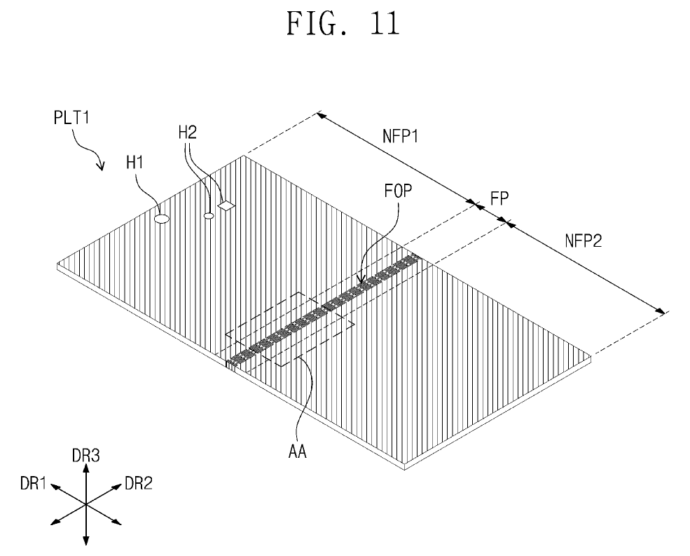

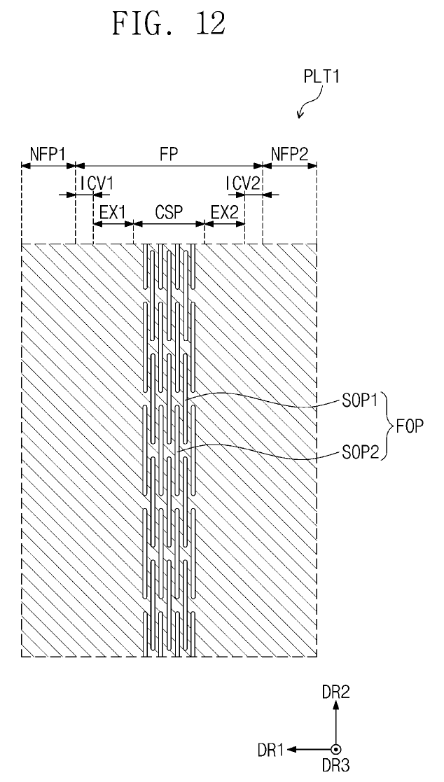

FIG. 11 is a perspective view of the first support plate illustrated in FIG. 10. FIG. 12 is an enlarged plan view of area AA illustrated in FIG. 11.

In an embodiment, in FIG. 11, the first support plate PLT1 is illustrated as a single layer, for example. However, without being limited thereto, the first support plate PLT1 may have a multi-layer structure.

Referring to FIGS. 11 and 12, the first support plate PLT1 may include the first non-folding portion NFP1, the folding portion FP, and the second non-folding portion NFP2. The first non-folding portion NFP1, the folding portion FP, and the second non-folding portion NFP2 of the first support plate PLT1 may correspond to the first non-folding portion NFP1, the folding portion FP, and the second non-folding portion NFP2 of the first support plate PLT1 illustrated in FIG. 10, respectively. The first non-folding portion NFP1, the folding portion FP, and the second non-folding portion NFP2 may be arranged in the first direction DR1.

In addition, the first support plate PLT1 may include the first reverse curvature portion ICV1, the first extension EX1, the curved portion CSP, the second extension EX2, and the second reverse curvature portion ICV2. The first reverse curvature portion ICV1, the first extension EX1, the curved portion CSP, the second extension EX2, and the second reverse curvature portion ICV2 of the first support plate PLT1 may correspond to the first reverse curvature portion ICV1, the first extension EX1, the curved portion CSP, the second extension EX2, and the second reverse curvature portion ICV2 of the first support plate PLT1 illustrated in FIG. 10, respectively. The first reverse curvature portion ICV1, the first extension EX1, the curved portion CSP, the second extension EX2, and the second reverse curvature portion ICV2 may be arranged in the first direction DR1.

Referring to FIGS. 11 and 12, a grid pattern may be defined in the curved portion CSP. Specifically, the folding openings FOP defined in the curved portion CSP may be arranged according to a predetermined rule. The folding openings FOP may be arranged in a grid shape to form the grid pattern of the curved portion CSP.

The first hole area H1 and the second hole areas H2 may be defined in the first non-folding portion NFP1. The first hole area H1 and the second hole areas H2 may be next (adjacent) to the border of the first non-folding portion NFP1. The first hole area H1 may correspond to the first hole area H1 illustrated in FIG. 8, and the above-described camera CM may be disposed in the hole defined in the first hole area H1. The second hole areas H2 may correspond to the second hole areas H2 illustrated in FIG. 8, and the above-described sensors SN may be disposed in the holes defined in the second hole areas H2.

The folding openings FOP may extend longer in the second direction DR2 than in the first direction DR1.

The folding openings FOP may include a plurality of first sub-openings SOP1 arranged in the second direction DR2 and a plurality of second sub-openings SOP2 next (adjacent) to the first sub-openings SOP1 in the first direction DR1 and arranged in the second direction DR2. The first sub-openings SOP1 may be staggered with respect to the second sub-openings SOP2.

FIG. 13 is a view illustrating a folded state of the display device illustrated in FIG. 10.

In an embodiment, in FIG. 13, the display module DM is illustrated as a single layer, for example. In addition, the first support plate PLT1 is illustrated together with the display module DM, and other components are omitted for convenience of description.

The folding portion FP illustrated in FIG. 13 may include the first reverse curvature portion ICV1, the first extension EX1, the curved portion CSP, the second extension EX2, and the second reverse curvature portion ICV2 that correspond to the first reverse curvature portion ICV1, the first extension EX1, the curved portion CSP, the second extension EX2, and the second reverse curvature portion ICV2 illustrated in FIG. 10, respectively.

Referring to FIG. 13, the first support plate PLT1 may be folded about the folding axis FX. As the first support plate PLT1 is folded, the display module DM may be folded together with the first support plate PLT1.

The folding portion FP may be folded about the folding axis FX so that the first support plate PLT1 may be folded. When the folding portion FP is folded, the curved portion CSP may be bent to have a predetermined curvature. The curved portion CSP may be bent to have a radius of curvature Rc. The folding area FA may be folded depending on the folding of the folding portion FP.

The first reverse curvature portion ICV1 may be bent opposite to the curved portion CSP. The second reverse curvature portion ICV2 may be bent opposite to the curved portion CSP. The second reverse curvature portion ICV2 may have a shape symmetrical to that of the first reverse curvature portion ICV1.

When the folding portion FP is folded, the first non-folding portion NFP1 and the second non-folding portion NFP2 may remain flat. Accordingly, the first non-folding area NFA1 and the second non-folding area NFA2 may be maintained in a flat state by the first non-folding portion NFP1 and the second non-folding portion NFP2.

The first extension EX1 may remain flat between the curved portion CSP and the first reverse curvature portion ICV1. The second extension EX2 may remain flat between the curved portion CSP and the second reverse curvature portion ICV2.

When the folding portion FP is folded, the distance between the first non-folding portion NFP1 and the second non-folding portion NFP2 in the first direction DR1 may be smaller than the diameter of the circle having the radius of curvature Rc. Depending on this configuration, the first support plate PLT1 may be folded in a dumbbell shape. As the first support plate PLT1 is folded in a dumbbell shape, the display module DM may be folded in a dumbbell shape together with the first support plate PLT1.

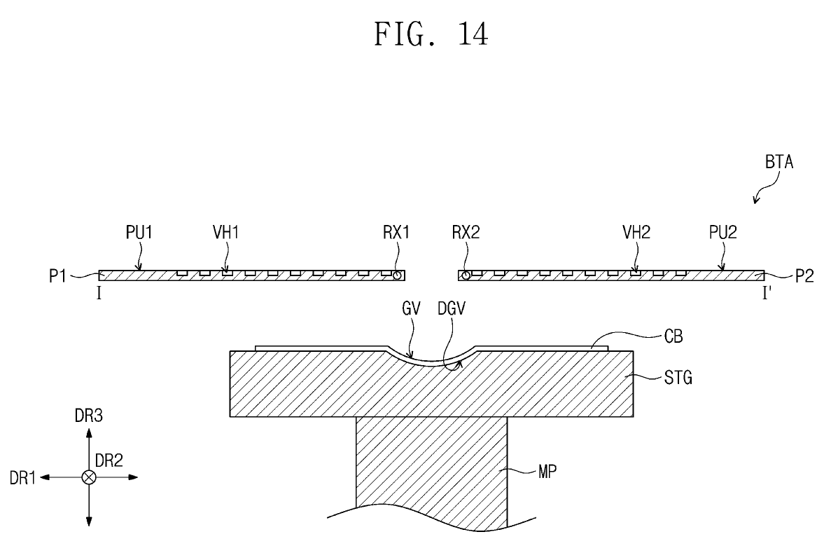

FIGS. 14-21 are cross-sectional views of the test device and the test object corresponding to line I-I’ illustrated in FIG. 1, where FIGS. 14 to 21 illustrate operations of a test method using the test device.

In an embodiment, the first plate P1, the second plate P2, the upper surface PU1 of the first plate, the upper surface PU2 of the second plate, the first vacuum holes VH1, the second vacuum holes VH2, the center part CB, the stage STG, and the moving part MP illustrated in FIGS, for example. 14 to 21 may correspond to the first plate P1, the second plate P2, the upper surface PU1 of the first plate, the upper surface PU2 of the second plate, the first vacuum holes VH1, the second vacuum holes VH2, the center part CB, the stage STG, and the moving part MP illustrated in FIG. 1, respectively. In the first rotating part RP1 and the second rotating part RP2 (illustrated in FIG. 1), the first rotation axis RX1 and the second rotation axis RX2 are illustrated, and the remaining components are omitted for convenience of description. FIGS. 14-21 are illustrated as cross-sectional views viewed in the second direction DR2.

Referring to FIG. 14, the test device BTA may be prepared. As described above, the first plate P1 and the second plate P2 may be spaced apart from each other in the first direction DR1, and the center part CB and the stage STG may be disposed under the first plate P1 and the second plate P2. In addition, the first rotation axis RX1 may be defined next (adjacent) to the one side of the first plate P1 that faces the one side of the second plate P2, and the second rotation axis RX2 may be defined next (adjacent) to the one side of the second plate P2 that faces the one side of the first plate P1.

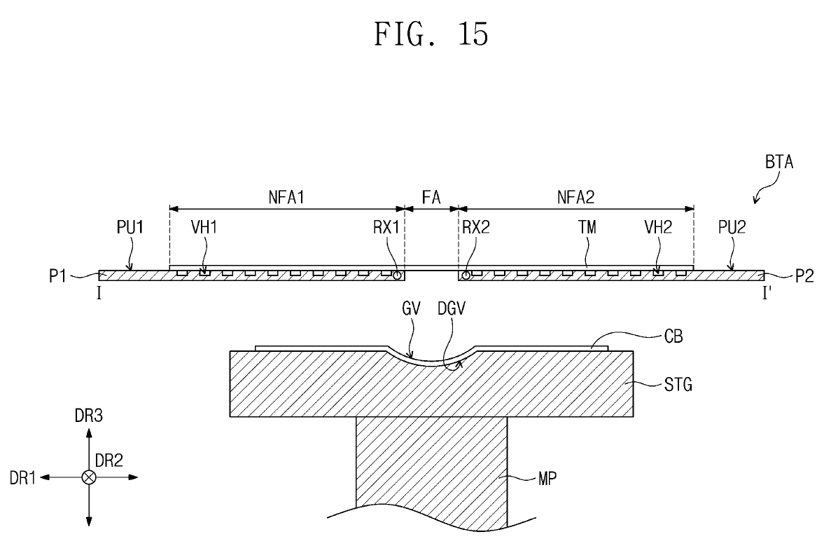

Referring to FIG. 15, the test object TM may be disposed on the test device BTA. Specifically, the test object TM may be provided on the first plate P1 and the second plate P2. The first non-folding area NFA1 of the test object TM may be provided on the upper surface PU1 of the first plate P1. The first non-folding area NFA1 may be fixed by the first vacuum holes VH1 defined in the upper surface PU1 of the first plate P1. In addition, the second non-folding area NFA2 of the test object TM may be provided on the upper surface PU2 of the second plate P2. The second non-folding area NFA2 may be fixed by the second vacuum holes VH2 defined in the upper surface PU2 of the second plate P2.

Referring to FIG. 16, the first plate P1 may rotate clockwise about the first rotation axis RX1 defined next (adjacent) to the one side of the first plate P1 that faces the one side of the second plate P2. The second plate P2 may rotate counterclockwise about the second rotation axis RX2 defined next (adjacent) to the one side of the second plate P2 that faces the one side of the first plate P1. The first plate P1 and the second plate P2 may rotate about the first rotation axis RX1 and the second rotation axis RX2 in the opposite directions so that the first non-folding area NFA1 and the second non-folding area NFA2 of the test object TM may be moved to face each other. As the first non-folding area NFA1 and the second non-folding area NFA2 are moved to face each other, the folding area FA disposed between the first non-folding area NFA1 and the second non-folding area NFA2 may be bent. The bent folding area FA may protrude further downward in the third direction DR3 than the one side of the first plate P1 next (adjacent) to the first rotation axis RX1 and the one side of the second plate P2 next (adjacent) to the second rotation axis RX2.

When the first plate P1 and the second plate P2 rotate, the stage STG and the center part CB may be moved upward by a predetermined distance in the third direction DR3 by the moving part MP.

Referring to FIGS. 16 and 17, the first non-folding area NFA1 and the second non-folding area NFA2 of the test object TM may face each other. When the first plate P1 and the second plate P2 rotate and the stage STG and the center part CB move upward in the third direction DR3, the folding area FA of the test object TM may be brought into contact with the groove GV of the center part CB and may be pressed by the groove GV of the center part CB. As the folding area FA is pressed, the test object TM may be folded in a dumbbell shape.

Referring to FIG. 18, for example, the window WIN is illustrated as the test object TM, and the protective film PF attached to the lower surface of the window WIN to prevent direct contact between the window WIN and the groove GV of the center part CB is illustrated. When a test is performed in the state in which the protective film PF is attached to the window WIN, the window WIN may not be brought into direct contact with the groove GV of the center part CB. Accordingly, deterioration of the window WIN due to contact with the test device BTA may be minimized. The protective film PF may be removed after the test. The window WIN tested using the test device BTA in an embodiment of the disclosure may be used to manufacture the electronic device ED (illustrated in FIG. 4) or ED’ (illustrated in FIG. 6) or the display device DD (illustrated in FIG. 8).

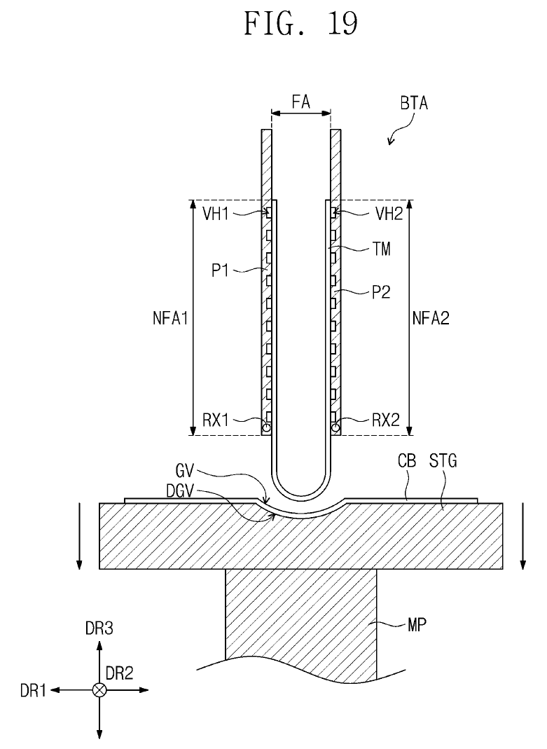

Referring to FIG. 19, the moving part MP may move the stage STG downward in the third direction DR3. As the stage STG is moved, the center part CB may be spaced apart from the folding area FA of the test object TM. As the center part CB is spaced apart from the folding area FA of the test object TM, the pressure may be released, and the folding shape of the test object TM may be changed from the dumbbell shape to a U-shape.

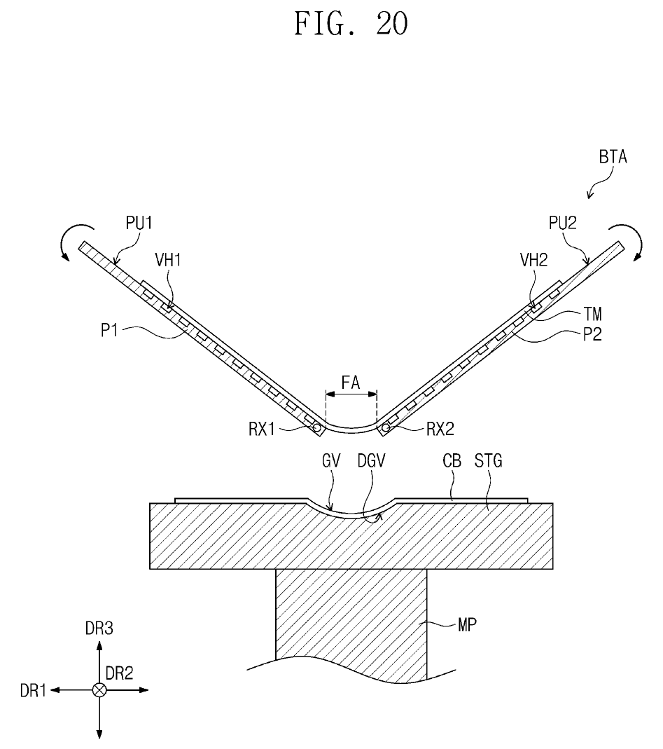

Referring to FIG. 20, the first plate P1 may rotate counterclockwise about the first rotation axis RX1. The second plate P2 may rotate clockwise about the second rotation axis RX2. The first plate P1 and the second plate P2 may rotate about the first rotation axis RX1 and the second rotation axis RX2 in the opposite directions so that the first non-folding area NFA1 and the second non-folding area NFA2 of the test object TM may be unfolded so as not to face each other.

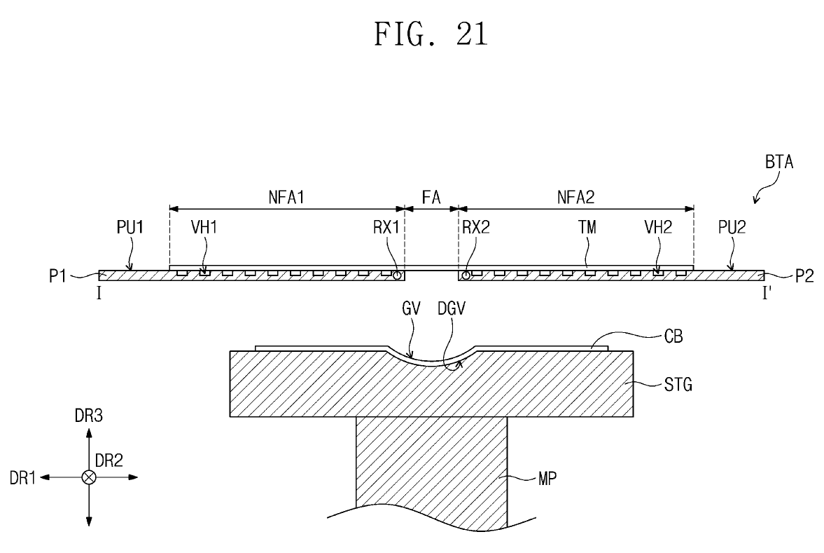

Referring to FIG. 21, the tested test object TM may return to the initial placement state, as illustrated in FIG. 15. Depending on whether the test object TM is damaged, the test object TM may be determined to be normal or defective. The test object TM determined to be normal may be used in a subsequent process, and the test object TM determined to be defective may be discarded.

In an embodiment of the disclosure, the test device BTA may include, under the first plate P1 and the second plate P2, the stage STG, the center part CB, and the moving part MP that moves the stage STG and the center part CB. The groove GV may be defined on the upper surface of the center part CB.

When the first plate P1 and the second plate P2 rotate about the first rotation axis RX1 and the second rotation axis RX2 so that the folding area FA of the test object TM is folded, the stage STG and the center part CB may move upward in the third direction DR3. As the groove GV of the center part CB moving upward presses the folding area FA of the test object TM, the test object TM may be folded in a dumbbell shape and may be tested in the state of being folded in the dumbbell shape. Accordingly, the folding area FA of the test object TM may be easily tested in one operation. Since the test object TM is tested in one operation, degradation caused by multiple contacts between the test equipment and the test object TM may be minimized. Furthermore, since the placement position of the test object TM is not modified, the test time may be shortened. In addition, since the test object TM is capable of being tested in the state of being folded in a dumbbell shape, stress may be applied to the same point as the point where the finished product (i.e., when manufactured as the electronic device or the display device) is subjected to stress in the folded state, which contributes to improving the reliability of the product.

In the embodiments of the disclosure, the test device may include the first plate and the second plate that are spaced apart from each other in the first direction and on which the test object is disposed and the stage and the center part that are disposed under the first plate and the second plate and that overlap the folding area of the test object. When the first plate and the second plate rotate to fold the folding area of the test object, the stage and the center part may move upward and may press the folding area, and the folding area may be tested to have a dumbbell shape. Thus, the dumbbell shape of the folding area may be easily tested in one operation.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. A test device comprising:
a first plate including:
a first upper surface on which a first non-folding area of a test object is disposed;
a second plate including:
a second upper surface on which a second non-folding area of the test object is disposed, the second plate being spaced apart from the first plate in a first direction;
a center part disposed under the first plate and the second plate; and
a stage disposed under the center part,
wherein a groove which overlaps a folding area of the test object disposed between the first non-folding area and the second non-folding area is defined on an upper surface of the center part.

2. The test device of claim 1, wherein a plurality of first vacuum holes which fix the first non-folding area are defined in the first plate, and
wherein a plurality of second vacuum holes which fix the second non-folding area are defined in the second plate.

3. The test device of claim 1, wherein the folding area does not overlap the first plate and the second plate.

4. The test device of claim 1, wherein the test object includes a window.

5. The test device of claim 4, wherein the test object further includes a protective film disposed on a lower surface of the window.

6. The test device of claim 1, wherein the first plate rotates about a first rotation axis, wherein the first rotation axis extends in a second direction crossing the first direction and is defined next to one side of the first plate which face one side of the second plate, and
wherein the second plate rotates about a second rotation axis, wherein the second rotation axis extends in the second direction and is defined next to the one side of the second plate which face the one side of the first plate.

7. The test device of claim 6, wherein the first plate and the second plate rotate about the first rotation axis and the second rotation axis in opposite directions to move the first non-folding area and the second non-folding area so that the first non-folding area and the second non-folding area face each other.

8. The test device of claim 7, wherein the stage moves a predetermined distance upward in a third direction crossing a plane defined by the first direction and the second direction when the first plate and the second plate rotate.

9. The test device of claim 8, wherein the folding area is brought into contact with the groove of the center part and pressed by the groove of the center part when the first plate and the second plate rotate and the stage moves upward in the third direction.

10. The test device of claim 9, wherein the test object is folded in a dumbbell shape.

11. The test device of claim 1, wherein the center part contacts an upper surface of the stage, and a dummy groove which overlaps the groove of the center part is defined on the upper surface of the stage.

12. The test device of claim 1, wherein the center part has a lower hardness than the test object.

13. The test device of claim 1, wherein the center part includes silicone.

14. A test method comprising:
placing, on a first plate and a second plate spaced apart from each other in a first direction, a test object including a first non-folding area which overlaps the first plate, a second non-folding area which overlaps the second plate, and a folding area disposed between the first non-folding area and the second non-folding area;
making the first non-folding area and the second non-folding area face each other by rotating the first plate about a first rotation axis and rotating the second plate about a second rotation axis, wherein the first rotation axis extends in a second direction crossing the first direction and is defined next to one side of the first plate which faces one side of the second plate, and the second rotation axis extends in the second direction and is defined next to the one side of the second plate which faces the one side of the first plate; and
pressing the folding area using a center part disposed on an upper surface of a stage by moving the stage upward by a predetermined distance in a third direction crossing a plane defined by the first direction and the second direction, the stage being disposed under the folding area,
wherein a groove which overlaps the folding area is defined on an upper surface of the center part.

15. The test method of claim 14, further comprising:
spacing the center part apart from the folding area by moving the stage downward in the third direction.

16. The test method of claim 14, wherein the first plate and the second plate rotate about the first rotation axis and the second rotation axis in opposite directions to move the first non-folding area and the second non-folding area so that the first non-folding area and the second non-folding area face each other.

17. The test method of claim 14, wherein the folding area is brought into contact with the groove and pressed by the groove when the first plate and the second plate rotate and the stage moves upward.

18. The test method of claim 17, wherein the test object is folded in a dumbbell shape.

19. The test method of claim 14, wherein the center part has a lower hardness than the test object.

20. An electronic device comprising:
a processor; and
a display device configured to receive an image signal from the processor and provide an image corresponding to the image signal to a user, the display device including:
a display panel; and
a window disposed on the display panel and tested by a test device including:
a first plate including:
a first upper surface on which a first non-folding area of the window is disposed,
a second plate spaced apart from the first plate in a first direction and including:
a second upper surface on which a second non-folding area of the window is disposed, a center part disposed under the first plate and the second plate, and a stage disposed under the center part, and
wherein a groove which overlaps a folding area of the window disposed between the first non-folding area and the second non-folding area is defined on an upper surface of the center part.
